(19) United States
(12) Patent Application Publication
(10) Pub. No.: US 2009/0211918 A1
(43) Pub. Date: Aug. 27, 2009

(54) ELECTROCHEMICAL CELL AND METHOD FOR OPERATING THE SAME

(75) Inventor: Kenneth L. Hardee, Middlefield, OH (US)

Correspondence Address: ESCHWEILER & ASSOCIATES, LLC;NATIONAL CITY BANK BUILDING, 629 EUCLID AVE., SUITE 1000, CLEVELAND, OH, 44114, US

(73) Assignee: Industrie De Nora S.p.A., Milan (IT)

(21) Appl. No.: 12/051,054

(22) Filed: Mar. 19, 2008

Related U.S. Application Data
(60) Provisional application No. 60/919,216, filed on Mar. 20, 2007.

(51) Int. Cl. C25B 1/26; C25B 9/00; C25B 1/02; C02F 1/461; C25B 11/00

(52) U.S. Cl. 205/556; 204/242; 204/253; 204/282; 205/628; 205/742; 204/280

(57) ABSTRACT

The invention relates to an electrochemical cell comprising an arrangement of anode/cathode pairs, in which the accumulation of scales or similar fouling phenomena are prevented by alternatively operating either the anode or the cathode of one pair and the corresponding counterelectrode of the adjacent pair, the non-operated electrode of each pair being at open circuit. The electrolyte dissolves the scale deposits on the electrodes at open circuit, without resorting to harmful current reversal.

### CROSS-REFERENCE TO RELATED APPLICATION

This application claims benefit of provisional application Ser. No. 60/919,216, filed Mar. 20, 2007, the entirety of which is incorporated herein by reference.

### FIELD OF THE INVENTION

The invention relates to the field of electrochemical cells, especially cells for electrolytic treatment of water.

### BACKGROUND OF THE INVENTION

There are known in the art several electrochemical cells for electrolytic water treatment, for instance cells generating hypochlorite or ozone for water disinfection, or cells evolving oxygen for biocide treatments. One of the main issues of these cells is the formation of fouling products such as insoluble salt scales, algae or other microorganism growth, and the like, especially on the surface of cathodes in the cell. Such fouling products are typically non-conductive and are detrimental to the current efficiency of the electrochemical processes, as well as impeding the access of the electrolyte to the active reaction sites, and must be periodically removed. In principle, this implies dismantling the cells in which the fouled electrodes are installed, with a net loss of productivity in addition to the primary cost of the maintenance procedure. Moreover, electrodes for electrochemical applications often include an inert conductive substrate coated with thin layers of catalytically active components, which in many cases comprise very expensive noble metals or oxides thereof. The removal of salt scales or algae from these active electrode surface by mechanical means is associated with the risk of damaging such delicate active coatings, implying still heavier economic losses.

One measure disclosed in the prior art to avoid these expensive and risky maintenance procedures consists of periodically reversing the polarity of the electrodes for a limited period of time, which may lead to establishing transient conditions favouring the detachment or the dissolution of scales (e.g. locally increasing the acidity in the proximity of a fouled cathode surface temporarily working as anode) or a biocide action directed against algae (e.g. temporarily evolving chlorine on a fouled cathode surface).

Different embodiments of this technique, known in the art as current reversal, are known and have been used in such applications as for seawater electrolysis with hypochlorite generation, current reversal in chlorinators for swimming pool water, and in removal of calcium carbonate scales in a water electrolysis process. In all of these examples, the cathodes periodically work as anodes for a limited time in predetermined cycles; the longer the operating time in current reversal mode, the more effective the electrode cleaning.

Nevertheless, if the functioning in reverse condition is too lengthy, besides resulting in a possible net current efficiency decrease when the cell operates in a cleaning mode without producing the desired products, damage to the electrodes can also occur. In most cases, the anodic operation of cathodes is detrimental to the integrity of materials specifically designed for cathodic operation, including a few preferred cathode substrate materials such as stainless steel, nickel and nickel alloys. In most cases, a cell designed to operate with intermittent current reversal is forced to utilise titanium cathodes, which must be protected with suitable layers of noble metal coatings. On the other hand, the detrimental effect of current reversal can also be very heavy on specifically designed anode materials forced to operate as cathodes, and typically subject, in current reversal mode, to hydrogen evolution, which is not a harmless reaction for all coating and substrate materials. The degree of freedom in choosing the construction materials for cells to be operated with periodic current reversal is therefore reduced, and a compromise is typically needed to meet all the different requirements. Examples of typical industrial applications which are affected to a significant extent by the above limitations are the above cited chlorination of swimming pool water, especially when the hardness of the water to be treated is high, and the on-board treatment of ballast waters of ships, required by international regulations to destroy non-native forms of marine living beings and affected both by scaling phenomena and by biological cathode fouling.

It would be desirable, then, to provide an electrochemical cell in which the removal of fouling products is achieved without interruption of production and without reversing the polarity of the electrodes. It would also be desirable to provide an electrochemical cell suitable for the generation of oxygen and/or hypochlorite, for the biocide treatment of ballast waters, or for chlorination of water for swimming pools.

### SUMMARY OF THE INVENTION

In one embodiment, the invention is directed to an electrochemical cell comprising a first and a second anode/cathode pair, each of the anode/cathode pairs comprising a cathode and an anode separated by a non-conductive member and at least one actuating means connecting the first and second anode/cathode pairs to a power source, the actuating means and the power source suitable for alternatively feeding direct electrical current, in a first operative state, to the cathode of the first anode/cathode pair and to the anode of the second anode/cathode pair, the remaining cathode and anode being at open circuit; and in a second operative state, to the cathode of the second anode/cathode pair and to the anode of the first anode/cathode pair, the remaining cathode and anode being at open circuit.

In another embodiment, the invention is directed to an electrode assembly comprising (a) at least two anode/cathode pairs, each pair comprising an anode, a non-conductive member, a cathode; and (b) connections to an actuating means capable of directing anodic currents to the anode and cathodic currents to the cathode.

In a further embodiment, the invention is directed to an electrode assembly comprising (a) a plurality of anode/cathode groups comprising a center anode positioned between cathode pairs; (b) first and second terminal anode/cathode pairs at ends of the assembly; and (c) actuating means capable of directing anodic currents to the anode and cathodic currents to the cathode.

In a still further embodiment, the invention is directed to an anode/cathode pair in combination with an actuating means capable of directing anodic currents to the anode and cathodic currents to the cathode, wherein the anode or the cathode of the pair alternates operation in a first operative state or a second operative state.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### BRIEF DESCRIPTION OF THE DRAWINGS

FIG. 1 illustrates a cell according to an embodiment of the invention comprising an actuating means consisting of an arrangement of electromechanical switches.

FIG. 2 illustrates a cell according to an embodiment of the invention comprising an actuating means consisting of an arrangement of diodes.

FIG. 3 illustrates a cell according to an embodiment of the invention comprising an assembly of two additional anode/cathode pairs in a pseudo-bipolar arrangement.

FIG. 4 illustrates an assembly according to a further embodiment of the invention comprising a plurality of anode/cathode groups arranged to form a plurality of chambers within the cell.

FIG. 5 illustrates an assembly according to an embodiment of the invention comprising an alternative embodiment of FIG. 4.

FIG. 6 illustrates a set of electrodes operated in accordance with the invention, a set of non-operated electrodes and a set of comparative electrodes.

### DETAILED DESCRIPTION

One or more implementations of the invention will now be described with reference to the attached drawings, wherein like reference numerals are used to refer to like elements throughout, and wherein the illustrated structures are not necessarily drawn to scale.

For purposes of the invention, the following terms shall have the following meanings:

The term “a” or “an” entity refers to one or more of that entity; for example, “an anode” or “an anode/cathode pair” refers to one or more of those anodes or at least one anode. As such, the terms “a” or “an”, “one or more” and “at least one” can be used interchangeably herein. It is also to be noted that the terms “comprising”, “including”, and “having” can be used interchangeably. Furthermore, a compound “chosen from one or more of” refers to one or more of the compounds in the list that follows, including mixtures (i.e. combinations) of two or more of the compounds.

The invention comprises an electrochemical cell having electrodes arranged in anode/cathode pairs, the anode and the cathode of each pair being separated by a non-conductive medium, connected to a power source through an actuating means suitable for alternatively feeding direct electrical current to the cathode of one pair and to the anode of the other pair in a first operative state, then to the anode of the first pair and to the cathode of the second pair in a second operative state, wherein the anodes and cathodes not supplied with electrical current in each operative state are held at open circuit.

The actuating means includes one or more of an arrangement of relays or other type of electromechanical or electronic solid state switch known in the art, or an arrangement of diodes, which is capable of directing anodic currents to the anode and cathodic currents to the cathode. In either case, the switches or diodes can be installed within a power source or directly attached to the electrodes, in the cell or in the wiring to the cells. When electromechanical or electronic (solid state) switches are used, the power source comprises a continuous power source and the switches are arranged in couples of cooperatively operating double switches, one double switch alternatively connecting the anode or the cathode of an anode/cathode pair to the power source, and the other double switch connecting the electrode of opposite polarity of the adjacent anode/cathode pair to the power source. Such electromechanical or solid state relays may be of the form commonly known as “double pole-double throw”.

When diodes are used, the power source comprises a reversing direct electrical current source and the diodes are arranged in couples of opposite polarity, each couple of diodes being connected to one anode/cathode pair so that all the diodes connecting the anodes to the power source have one polarity and all the diodes connecting the cathodes to the power source have an opposite polarity. For more than two (2) anode/cathode pairs, it is also possible to employ a single set of four (4) diodes such that a pair of diodes controls the current flow to a set of electrode pairs connected in parallel, while the second pair of diodes controls the flow of current to the second set of electrode pairs also connected in parallel.

For an appropriate functioning of the cell of the invention, the cathodes and/or the anodes, are, in one embodiment, foraminous in order to prevent obstruction of the electrolyte and current flow. The cathodes may be manufactured out of any typical cathodic material known in the art, including one or more of stainless steel, nickel or nickel alloy, while the anodes comprise a titanium substrate provided with a catalytic coating made of noble metals or oxides thereof. Such an arrangement allows for an increase in the lifetime of the anode coating by avoiding its operation in current reversal mode, as well as allowing for alternative cathodes materials. Titanium cathodes are subject to hydridisation, which can be an additional limiting factor for cell lifetime. Since the cathodes of the cell in accordance with the invention do not need to be operated as anodes, alternative materials such as stainless steel and nickel alloys, for instance alloys of the Inconel® or Hastelloy® families, may be used, which in addition do not need to be catalysed. Hastelloy® is a trade-mark of Haynes Ltd., and Inconel® is a trade-mark of INCO Ltd. Other metallic substrates may also be used as warranted for a particular application, including zirconium, niobium and tantalum, or alloys thereof. In one embodiment, an electrocatalytic coating can be applied to the cathode substrate to facilitate the cathodic reaction. In one embodiment, the electrocatalytic coatings include metals or oxides of the platinum group, alone or in combination. In another embodiment, high surface area materials, such as Raney nickel or other porous nickel materials (Ni/Zn, Ni/Al, Ni/Al/Mo) may also be used. For some applications, such as ozone generation or organic destruction or organic synthesis, the use of boron doped diamond (BDD) as an anode material (alone or applied to a suitable substrate) will be appropriate. BDD may also be used as the cathode material, alone or as a coating. Similarly, the Ti suboxides known as Magneli phases (e.g. Ti₄O₇) may also be used as anodes or cathodes, as coatings or monolithic structures.

The cathodes may be woven wire materials, expanded metal, punched plate or any other open structure. The cathodes may be formed by strips or thin rods with spacing between to allow electrolyte circulation. The cathodes also may be shorter than the anodes, or offset from the anodes, to allow the acidic electrolyte to flow over the leading edge of the cathode to facilitate removal of the scale there. The electrodes may also comprise two or more pairs of concentric cylinders where a foraminous cathode (e.g. mesh) is formed into a cylindrical shape and then mounted near, but not in electrical contact with, a sheet (or mesh) anode. A smaller pair of similarly formed electrodes is then mounted concentric to the first pair.

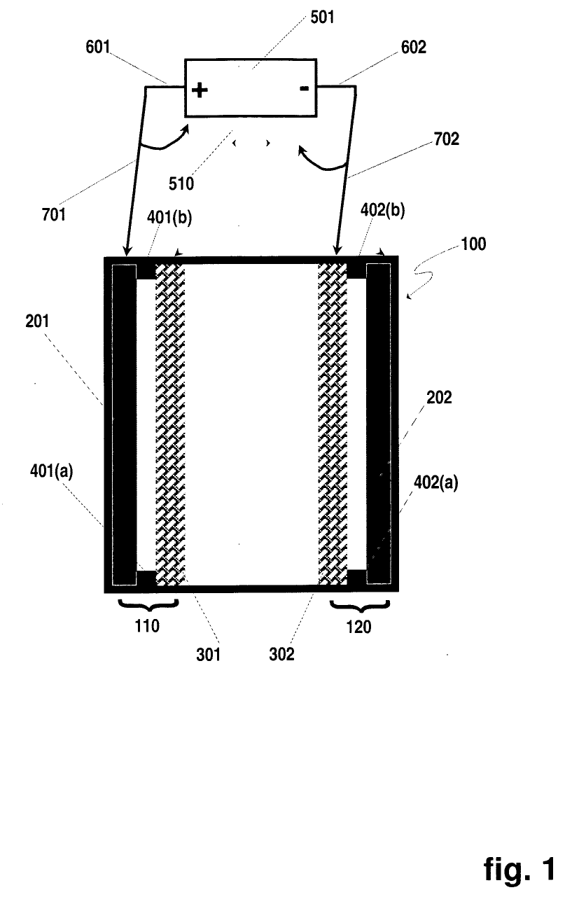

FIG. 1 shows an embodiment of the cell of the invention (100). The cell (100) comprises at least two anode/cathode pairs (110,120). A first anode/cathode pair (110), comprises a plate anode (201) and a mesh cathode (301) separated by one or more non-conductive members (401a), (401b) and a second anode/cathode pair (120) comprises a plate anode (202) and a mesh cathode (302) separated by one or more non-conductive members (402a), (402b). The spacing or gap between the anode and cathode is determined by mechanical considerations to avoid shorting of anode/cathode as well as blinding of the anode. In one embodiment, the gap will be from about 0.05 mm to about 10 mm. In another embodiment, the gap will be from about 0.5 mm to about 1.5 mm. The correct spacing between two adjacent anode/cathode pairs is also important to allow consistent, effective cleaning. In one embodiment, the spacing between anode/cathode pairs, expressed as the distance between the cathode of one pair and the facing cathode of the adjacent pair will be from about 3.0 mm to about 4.5 mm. In the embodiment illustrated in FIG. 1, the non-conductive members (401a,b), (402a,b) comprise a plurality of non-conductive discontinuous spacers positioned between anode/cathode pairs (110), (120). In another embodiment, the non-conductive member comprises one or more strips of non-conductive material. In a further embodiment, the anode/cathode pair (110), (120) are held in a separated position without the use of a non-conductive member, such as by a slotted end piece or a tabbed configuration.

In one embodiment, the non-conductive members (401a,b), (402a,b) comprise any electrically non-conductive material, such as a polymeric material, including but not limited to polypropylene; polytetraflouroethylene (PTFE); ethylene chlorotrifluoro-ethylene polymer (ECTFE), e.g., Halar®, a registered trademark of Ausimont Chemical Company; polyethylene; polyvinylidene fluoride (PVDF) e.g., Kynar®, a registered trademark of E.I. DuPont De Nemours Company; polyvinylchloride (PVC); chlorinated polyvinyl chloride (CPVC);or neoprene. In one embodiment, the non-conductive material is a rubber material, including, among others, EPDM; and Viton®, a registered trademark of E. I. Du Pont De Nemours & Company.

The cathodes (301), (302) face each other, with solid anodes (201), (202) being arranged externally thereto, but one skilled in the art can easily derive other equivalent electrode arrangements, for instance with foraminous anodes facing each other with solid cathodes arranged externally. In one embodiment, the anodes and cathodes may both be foraminous.

Cell (100) is connected to the poles of a continuous power source (501) through an actuating means comprising two cooperatively operated double switches, a first switch (701) connected to the positive pole (601) of power source (501) and a second switch (702) connected to the negative pole (602) of power source (501). A timer (510) or other equivalent means known in the art controls the simultaneous operation of switches (701) and (702) as depicted by the curved arrows. The position of the switches thus periodically alternates between the configuration indicated by the solid straight arrows, with anode (201) connected to the positive pole (601) and cathode (302) connected to the negative pole (602), and the configuration indicated by the dotted arrows, with anode (202) connected to the positive pole (601) and cathode (301) connected to the negative pole (602). In the former configuration, electrodes (201) and (302) are energised in a first operative state such that the electrodes are active, and electrodes (301) and (202) are in a second operative state such that the electrodes are non-active or at open circuit. Conversely, in the latter configuration, electrodes (201) and (302) are at open circuit and electrodes (301) and (202) are energised. For instance, in the case of a hypochlorite cell for pool chlorinators affected by calcium and magnesium carbonate scaling, the acidic electrolyte resulting from the generation of chlorine and oxygen at the energised anode flows through the nearby open circuit cathode causing the scale to dissolve. The anode of the other anode/cathode pair is also at open circuit and thus is not subjected to harmful operation as cathode.

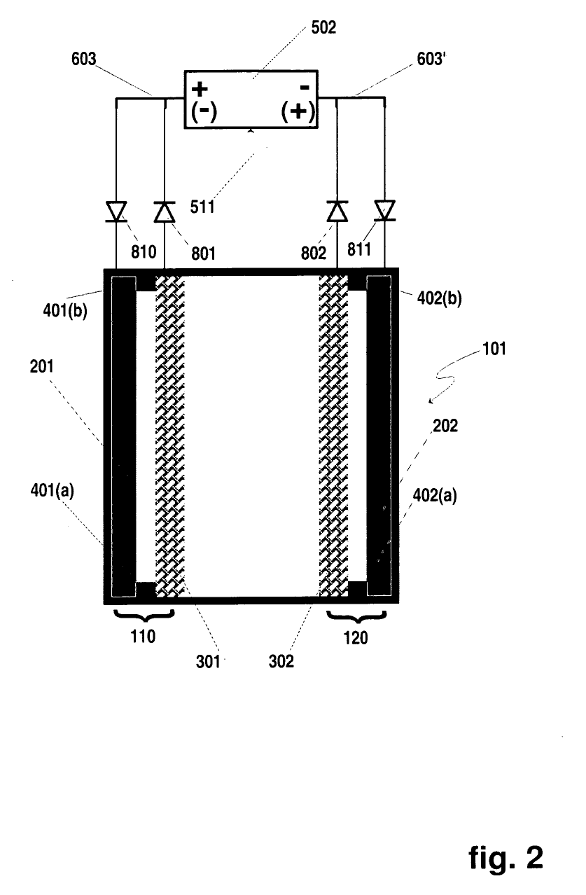

FIG. 2 shows another embodiment of the invention, wherein the cell (101) is substantially the same as FIG. 1 except that the actuating means for feeding a direct electrical current comprises an arrangement of diodes (801, 810), (802, 811). The elements in common with the cell of FIG. 1 are indicated with the same reference numerals. In this embodiment, the power source comprises a reversing direct electrical current source (502). The polarity inversion is controlled by a timer (511) or equivalent means known in the art. Each electrode of each anode/cathode pair is connected to the poles (603) and (603′) of the reversing current source (502) through at least one diode. The diodes (801) and (802) connecting the cathodes (301) and (302) to the respective poles (603) and (603′) have the same polarity, and the diodes (810) and (811) connecting the anodes (201) and (202) to the respective poles (603) and (603′) have the opposite polarity, as shown in FIG. 2. The functioning of cell (101) is the equivalent of that relative to cell (100) of FIG. 1. While the anode of one pair and the cathode of the other pair are energised, the remaining cathode and anode are essentially at open circuit by virtue of the diode arrangement, so that at any given time there are two electrodes carrying out the desired electrochemical process (working mode) and two left at open circuit (cleaning mode). In both cases, the parameters regulating the switching between the two configurations can be easily set by one skilled in the art depending on the requirements of the specific process. For example, the two configurations can be alternated with a period ranging from a few minutes to a few hours. One skilled in the art will also observe that cells (100) and (101) are suitable for being stacked in a modular arrangement giving rise to a monopolar electrolyser of the required size.

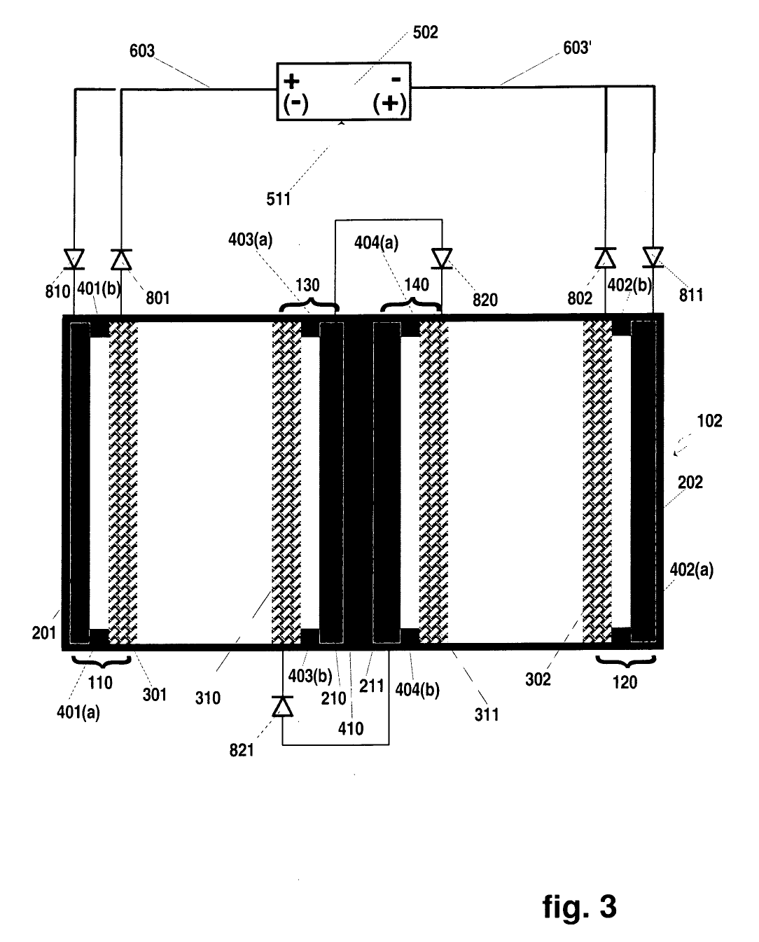

The cell (100) of the invention can be easily stacked in a modular fashion with other equivalent cells providing monopolar-type connections to form an electrolyser. Although in many cases monopolar electrolysers are the preferred choice to multiply the cell capacity, for other applications a bipolar-type electrolyser would be advantageous. While the cells according to the invention as hereinbefore described do not appear to be suitable for being connected in a bipolar-type fashion, a pseudo-bipolar electrolyser can be obtained by interposing assemblies. FIG. 3 shows an alternative embodiment wherein a pseudo-bipolar configuration provides a cell of double productive capacity with essentially the same features and advantages of a conventional two cell bipolar stack. This is obtained by intercalating assemblies each comprised of two additional anode/cathode pairs in one of the cells of the previous Figures. One skilled in the art will observe that the pseudo-bipolar arrangement of FIG. 3 can be obtained with any number of such interposed assemblies, until reaching the desired size. The pseudo-bipolar cell (102) of FIG. 3 derives from the interposition of one assembly of two additional anode/cathode pairs in the cell (101) of FIG. 2, but one skilled in the art will readily understand how to modify the cell (100) of FIG. 1 to achieve essentially the same result.

A shown in FIG. 3, the assembly of additional anode/cathode pairs of cell (102) comprises a first additional pair (130) comprising an anode (210) and a cathode (310) separated by one or more non-conductive members (403a) (403b), and a second additional pair (140) also comprising an anode (211) and a cathode (311) separated by one or more non-conductive members (404a), (404b). The two additional pairs (130), (140) of the assembly are disposed in a back-to-back relationship and separated by an impervious non-conductive member (410). Solid anodes and mesh cathodes are shown and the back-to-back relationship is obtained by interposing an impervious non-conductive member (410) between the two anodes (210) and (211), but one skilled in the art will easily identify different combinations of solid and foraminous electrodes arranged and oriented in different ways. As shown in the Figure, the anode (210) of the first additional pair (130) is connected to the cathode (311) of the second additional pair (140) through a diode (820), and the anode (211) of the second additional pair is connected to the cathode (310) of the first additional pair through another diode (821) with an opposite polarity of diode (820). In this way, depending on the polarity of power source (502), two of the cathodes, for instance (301) and (311), and two of the anodes, for instance (210) and (202), will be energised (working mode), while the remaining anodes and cathodes will be essentially at open circuit (cleaning mode).

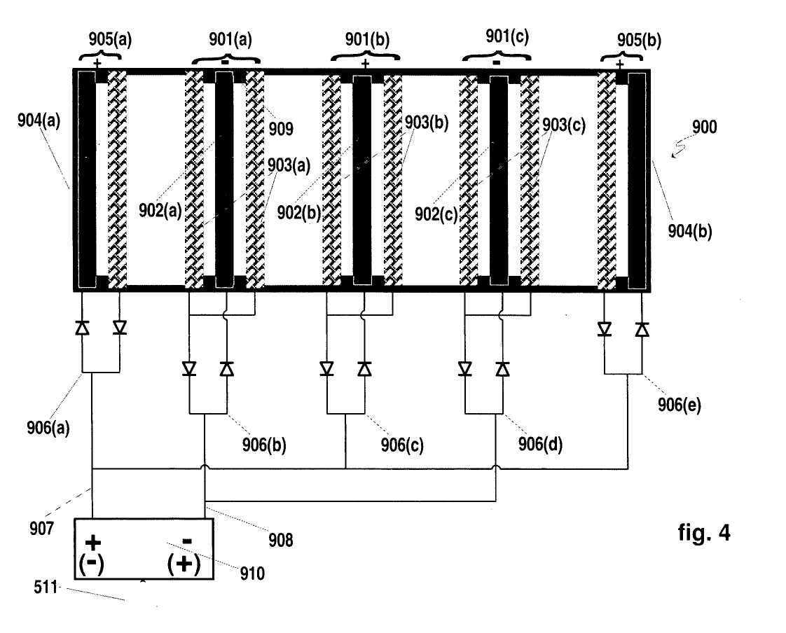

In FIG. 4 there is illustrated a further embodiment of the invention. The electrode assembly (900) comprises a plurality of anode/cathode groups (901a), (901b), (901c) in which a center anode (902a), (902b), (902c) is positioned between cathode pairs (903a), (903b), (903c) and separated by non-conductive members (909) on each side of center anode (902a), (902b), (902c). On ends (904a), (904b) of the assembly 900 are first and second terminal anode/cathode pairs (905a), (905b). Anode/cathode groups (901a), (901b), (901c), as well as terminal anode/cathode pairs (905a), (905b), are each connected through diodes (906a), (906b), (906c), (906d), (906e). Terminal pairs (905a), (905b) and group (901b) are connected to pole (907) of power supply (910) through diodes (906a), (906c) and (906e), and groups (901a), (901c) are connected to pole (908) of power supply (910) through diodes (906b) and (906e).

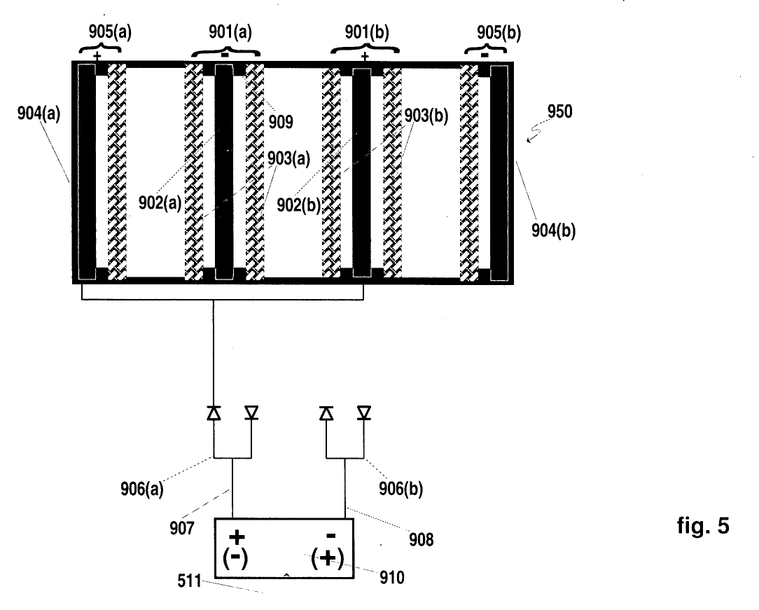

FIG. 5 illustrates an alternative embodiment of FIG. 4. Elements in common with the assembly of FIG. 4 are indicated with the same reference numerals. The assembly (950) comprises first and second anode/cathode groups (901a), (901b) comprising center plate anodes (902a), (902b) positioned between cathode pairs (903a), (903b) and separated by non-conductive members (909). The embodiment illustrated is substantially equivalent to the embodiment of FIG. 5, with the exception that the appropriate electrodes are connected in parallel prior to connection through an actuating means (906a), (906b) to minimize the number of diodes utilized, rather than a set of diodes for each anode/cathode group (901a), (901b) and pair, (905a), (905b), as in FIG. 5.

### EXAMPLES

The following examples are included to demonstrate particular embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

A titanium anode (0.89 mm thick) was coated with a commercial RuO₂/TiO₂ coating (De Nora Tech, Inc., Chardon, Ohio, formerly known as ELTECH Systems Corp.). The cathode was titanium expanded mesh (0.89 mm thick) which was etched in 18% HCl at 90° C. The electrodes were cut to 5.5 cm×15.25 cm. A 3.2 mm titanium rod was attached to the anode and another to the cathode. A pair of electrodes was fabricated by placing a small rubber gasket (0.55 mm) at each corner of the anode and then clamping the mesh cathode to the anode with plastic clamps. A 6 amp diode (Radio Shack 276-1661) was attached to each electrode, oriented such that anodic current would flow to the anode and cathodic current to the cathode. The opposite ends of the diodes from the electrodes were connected together. Two such anode/cathode pairs were inserted into a plastic housing fitting at each end with 2″ diameter threaded joints to form an electrochemical cell. The positive lead of a dc power supply was connected to one electrode pair through the diodes and the negative lead to the other electrode pair. Two such cells were prepared. Both cells were attached to a recirculating pump (30 g/m) connected to a 150 gallon tank containing 4 g/l NaCl with 300 mg/l Ca (as calcium carbonate). The cells were operated at 310 A/m2 at room temperature (ca. 20-25° C.) for 1 week. One cell was operated without current reversal. The other cell was operated with the current reversing every 3 hours, using an electronic timer/relay. After 1 week the cells were opened and examined for scale. The non-reversing cathode was heavily encrusted with scale obscuring the mesh structure, estimated to be about 5 mm thick. The reversing cell had less than 2 mm crust. The cells were cleaned and restarted using a 6-hour reversal cycle. After 1 week, examination of the cathodes showed only minimal deposit.

### Example 2

Two pairs of electrodes as in Example 1 were operated in 4 g/l NaCl, 70 g/l Na₂SO₄ at room temperature at 1000 A/m² with current reversal every 1 minute until the voltage escalated rapidly, indicating passivation. The time required was 1750 hours and 1950 hours for two separate tests. In comparison, operation of the same material as both an anode and a cathode, i.e. no attached mesh cathode, resulted in lifetimes of only 226 hours and 273 hours. Thus, the lifetime of the coated titanium substrate of the invention is extended by over 7 times, on average.

### Example 3

A cell containing two pairs of electrodes as in Example 1 were operated as in Example 1 with current reversal times of 10 minutes, 1 hour, 3 hours and 6 hours. After 5-8 days of operation the accumulated scale was significantly less than for a cell operated with no current reversal.

### Example 4

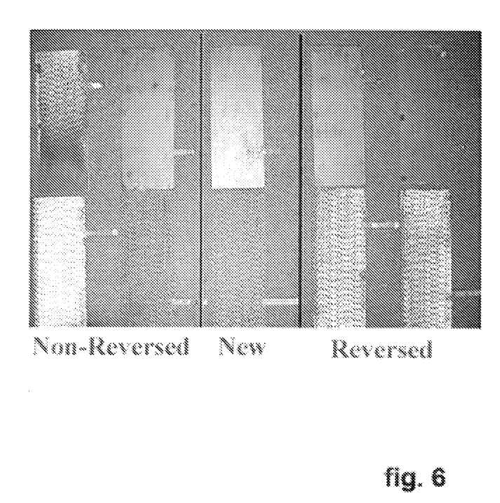

A set (2 pairs) of electrodes (5.3×15.3 cm) was mounted in a swimming pool chlorinator housing. Electrolyte from a 500 gallon tank was circulated through the pool chlorinator. The electrolyte was 4 g/l NaCl with 300 mg/l Ca (as CaCO3), pH 7.6-8.0, room temperature (20-25° C.). A second pool chlorinator housing was fitted with an identical set of electrodes (including diodes) and placed in series with the electrolyte flow of the first cell (but after the first cell). The first cell was connected to a power supply and a relay timer to reverse the current every 3 hours. The second cell was connected to an identical power supply, but the current was not reversed for this cell. The cells were operated continuously for 3.5 days at 30 mA/cm². Upon removal and disassembly, the electrodes had the appearance shown in FIG. 6. The mesh cathode in the non-reversed cell was almost filled with scale deposit. The adjacent (non-operating) anode also had a scale deposit. The anode and non-operating cathode were clean, as expected. For the cell with periodic current reversal (right set in FIG. 6), there was a light scale deposit on the cathode which had been “off” last (right cathode in FIG. 6), while there was a somewhat heavier deposition on the cathode that was last “on” (cathode second from right). Both were significantly less scaled than the control cathode. The anode/cathode pair in the center of FIG. 6 are non-operated electrodes for comparison.

Thus, it can be seen that with time the scale in the non-reversed cell would accumulate to such an extent that its cell performance would degrade, while the reversed cell can continue to operate indefinitely as the scale is periodically removed.

The above description shall be understood as not limiting the invention, which may be practiced according to different embodiments without departing from the scope thereof, and whose extent is encompassed by the appended claims.

What is claimed is:

1. Electrochemical cell comprising a first and a second anode/cathode pair, each of said anode/cathode pairs comprising a cathode and an anode separated by a non-conductive member and at least one actuating means connecting said first and second anode/cathode pairs to a power source, said actuating means and said power source suitable for alternatively feeding direct electrical current:
in a first operative state, to said cathode of said first anode/cathode pair and to said anode of said second anode/cathode pair, the remaining cathode and anode being at open circuit; and
in a second operative state, to said cathode of said second anode/cathode pair and to said anode of said first anode/cathode pair, the remaining cathode and anode being at open circuit.

2. The cell according to claim 1, wherein said at least one actuating means comprises an arrangement of diodes or of electromechanical or electronic switches.

3. The cell according to claim 1, wherein the distance between the anodes and cathodes in each pair ranges from about 0.05 mm to about 10 mm.

4. The cell according to claim 3, wherein the distance between the anodes and cathodes in each pair ranges from about 0.5 mm to about 1.5 mm.

5. The cell according to claim 1, wherein the distance between a cathode of one pair and the facing cathode of the adjacent pair ranges from about 3.0 mm to about 4.5 mm.

6. The cell according to claim 2, wherein said power source comprises a reversing direct electrical current source and said arrangement of diodes comprises a first and second couple of diodes, the diodes of each couple having opposite polarity, said first couple of diodes being connected to said first anode/cathode pair and said second couple of diodes being connected to said second anode/cathode pair, said diodes connecting said cathodes to said power source having the same polarity, said diodes connecting said anodes to said power source having an opposite polarity with respect to said diodes connecting said cathodes to said power source.

7. The cell according to claim 2, wherein said power source is a continuous power source and said electromechanical or electronic switches comprise a first and a second cooperatively operated double switch, said first double switch alternatively connecting said anode or said cathode of said first anode/cathode pair to said power source and said second double switch alternatively connecting said cathode or said anode of said second anode/cathode pair to said power source.

8. The cell according to claim 1, further comprising at least one assembly including two additional anode/cathode pairs interposed between said first and said second anode/cathode pairs, each additional pair comprised of a cathode and an anode separated by non-conductive medium, said additional anode/cathode pairs being disposed in a back-to-back relationship and separated by a non-conductive impervious medium, the anode of said first additional anode/cathode pair being connected to the cathode of said second additional anode/cathode pair through at least one first diode, the anode of said second additional anode/cathode pair being connected to the cathode of said first additional anode/cathode pair through at least one second diode, said at least first one diode and said at least one second diode of said additional anode/cathode pairs having opposite polarity.

9. The cell according to claim 5, wherein said cathodes are foraminous.

10. The cell according to claim 9, wherein cathodic materials of said cathodes comprise one or more of titanium, zirconium, tantalum, niobium and alloys thereof, stainless steel, nickel and nickel alloys, boron doped diamond, graphite, or vitreous carbon.

11. The cell according to claim 10, wherein the cathode material is provided with an electrocatalytic coating comprising platinum group metals or oxides and/or boron doped diamond.

12. The cell according to claim 1, wherein said anodes comprise a titanium substrate provided with a noble metal oxide coating.

13. The cell according to claim 12, wherein said anodes comprise a substrate provided with a coating of boron doped diamond or where a freestanding boron doped diamond anode is used.

14. The cell according to claim 1, wherein said anodes and/or cathodes comprise a Magneli phase titanium suboxide as a coating on a metallic substrate or as a monolithic electrode.

15. A monopolar electrolyser comprising a modular arrangement of cells according to claim 1.

16. An electrode assembly comprising:
(a) at least two anode/cathode pairs, each pair comprising an anode, a non-conductive member, a cathode; and
(b) connections to an actuating means capable of directing anodic currents to the anode and cathodic currents to the cathode.

17. The assembly of claim 16, wherein the actuating means comprises an arrangement of diodes.

18. The assembly of claim 16, wherein the actuating means comprises an electromechanical or electronic (solid state) relay.

19. A method of using an electrode for the generation of oxygen or hypochlorite, the method comprising providing the electrochemical cell of claim 1; and generating oxygen and/or hypochlorite in said cell.

20. A method of using an electrode for the biocidal treatment of ballast water comprising providing the electrochemical cell of claim 1; and biocidally treating ballast water.

21. A method of using an electrode for the chlorination of swimming pool water comprising providing the electrochemical cell of claim 1; and chlorinating the swimming pool water.

22. An anode/cathode pair in combination with an actuating means capable of directing anodic currents to the anode and cathodic currents to the cathode, wherein said anode or said cathode of said pair alternates operation in a first operative state or a second operative state.

23. The anode/cathode pair of claim 22, wherein said first operative state is an active state and said second operative state is a non-active state or open circuit.

24. An electrode assembly comprising:
a) a plurality of anode/cathode groups comprising a center anode positioned between cathode pairs;
b) first and second terminal anode/cathode pairs at ends of the assembly; and
c) actuating means capable of directing anodic currents to the anode and cathodic currents to the cathode.

25. The assembly of claim 24, wherein each electrode of each anode/cathode pair is connected to the poles of the reversing current source through at least one actuating means.

26. The assembly of claim 24, wherein each electrode of each anode/cathode group is connected in parallel prior to connection to the actuating means.
